(19) United States
(12) Patent Application Publication
(10) Pub. No.: US 2004/0085187 A1
(43) Pub. Date: May 6, 2004

(54) Depository system

(76) Inventors: Benjamin Gotfried, Hobe Sound, FL (US); Bradley L. Gotfried, Hobe Sound, FL (US)

Correspondence Address: Mark D. Passler, Suite 400, 222 Lakeview Ave., West Palm Beach, FL, 33401, US

(21) Appl. No.: 10/283,614

(22) Filed: Oct. 30, 2002

(51) Int. Cl. H04Q 1/00; G05B 19/00

(52) U.S. Cl. 340/5.52; 340/5.73

(57) ABSTRACT

An automated depository system having a sobriety detection mechanism and a storage unit for storing a deposited article in which the storage unit selectively releases the stored article based on measurements taken by the sobriety detection mechanism. In one arrangement, the sobriety detection mechanism can produce a blood alcohol content reading, and the storage unit can release the deposited article when the reading is below a predetermined value. Conversely, the storage unit can retain the article when the reading reaches a predetermined value. In another arrangement, the system can have circuitry for contacting a transportation service based on measurements taken by the sobriety detection mechanism.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

1. Technical Field

The present invention relates generally to systems for limiting the number of impaired drivers and more particularly, to sobriety detection systems.

2. Description of Related Art

Drunk driving is a major problem in the United States and many other countries. Despite the efforts of many agencies and organizations, people continue to drink and drive. As an example of these efforts, law enforcement officials have employed reactive measures in the battle against drunk driving such as administering field sobriety tests to drivers suspected of being intoxicated and setting up sobriety checkpoints. Although somewhat effective at removing drunken drivers from the road, these reactive measures have an inherent flaw in that they cannot be employed until an intoxicated driver has already driven his or her vehicle and jeopardized the safety of others.

In response, police departments and organizations such as Mothers Against Drunk Driving (MADD) have adopted proactive measures to combat the problem of driving under the influence. For example, police officers sometimes visit the nation's schools and community centers to explain the legal and moral ramifications of driving under the influence, and MADD broadcasts public service announcements warning the general public about the consequences of such irresponsible behavior. These steps appear to have had somewhat of an effect on the populace as many individuals designate a driver out of a group on a social gathering to remain sober for purposes of driving the others home while some people simply ride home in cabs when too drunk to drive.

While these proactive measures do indeed help control the prevalence of driving under the influence, there remains a shortcoming: in many situations, a drunk driver still has access to his or her keys. As a result, the number of accidents and deaths caused by drunk driving is still far too high. Thus, what is needed is a system that prevents a drunk driver from having access to his or her keys and only releases the keys when that driver is sober.

### SUMMARY OF THE INVENTION

The present invention concerns an automated depository system. The system includes a sobriety detection mechanism and a storage unit for storing a deposited article, such as a key. The storage unit selectively releases the deposited article based on measurements taken by the sobriety detection mechanism. In one arrangement, the sobriety detection mechanism can provide a blood alcohol content reading. In this arrangement, the storage unit can release the deposited article when the blood alcohol content reading is below a predetermined value and can retain the deposited article when the blood alcohol content reading reaches the predetermined value.

The system can also have circuitry for contacting a transportation service based on measurements taken by the sobriety detection mechanism. In one arrangement, the sobriety detection mechanism can provide a blood alcohol content reading, and the circuitry can contact a transportation service when the blood alcohol content reading reaches a predetermined value. In one aspect, the transportation service can be a taxi, a tow truck or a delivery service.

The system can further have structure for receiving payment from a user. In one arrangement, the structure can include circuitry for receiving data from an electronic transactional card. In addition, the system can have a user interface. The user interface can display measurements taken by the sobriety detection mechanism, and at least one of the measurements can be a blood alcohol content reading.

The system can also have a biometric identifier for identifying at least one biometric characteristic of an individual using the system. In one aspect, at least one of the biometric characteristics can be a fingerprint, a retinal scan or an iris scan.

The invention also concerns a method for storing articles. The method includes the steps of receiving at least one article, storing the article in a storage unit, taking measurements with a sobriety detection mechanism and selectively releasing the stored article based on the measurements taken by the sobriety detection mechanism. In one aspect, the method can further include the step of contacting a transportation service based on the measurements taken by the sobriety detection mechanism. The method can also include the steps of providing a biometric identifier and identifying at least one biometric characteristic of an individual with the biometric identifier.

### BRIEF DESCRIPTION OF THE DRAWINGS

FIG. 1 illustrates an automated depository system in accordance with the inventive arrangements.

FIG. 2A illustrates a sobriety detection mechanism in accordance with the inventive arrangements.

FIG. 2B illustrates another sobriety detection mechanism in accordance with the inventive arrangements.

FIG. 2C illustrates another sobriety detection mechanism in accordance with the inventive arrangements.

FIG. 2D illustrates yet another sobriety detection mechanism in accordance with the inventive arrangements.

FIG. 3A illustrates a biometric identifier in accordance with the inventive arrangements.

FIG. 3B illustrates another biometric identifier in accordance with the inventive arrangements.

FIG. 3C illustrates yet another biometric identifier in accordance with the inventive arrangements.

FIG. 4 illustrates a method for automatically storing articles in an automated depository system in accordance with the inventive arrangements.

### DETAILED DESCRIPTION OF THE PREFERRED EMBODIMENTS

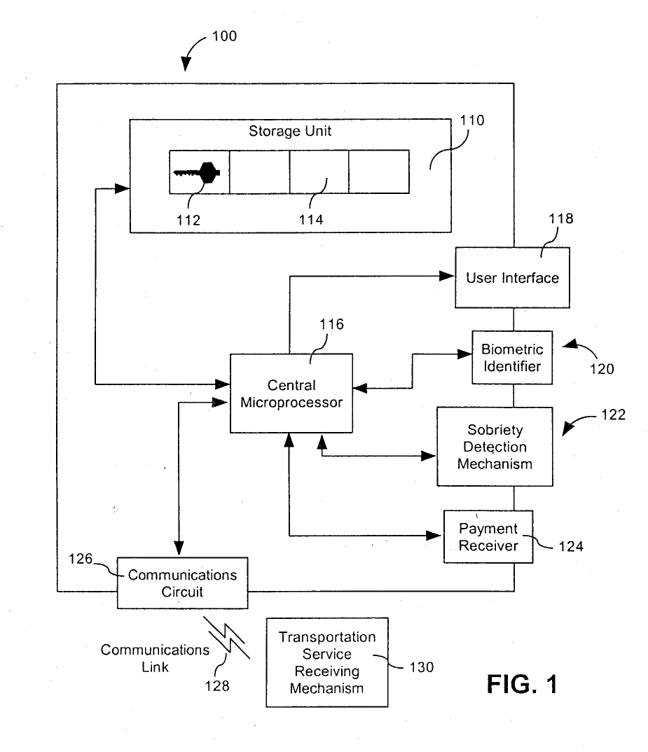

Referring to FIG. 1, an automated depository system 100 in accordance with the inventive arrangements is shown. The system 100 can include a storage unit 110 for storing one or more articles 112. As an example and as shown in FIG. 1, the article 112 can be a set of keys, at least one of which is a vehicle or vessel ignition key. It is understood, however, that the invention is not so limited, as the article 112 can be any other item suitable for storage, such as a firearm. The storage unit 100 can contain one or more bins 114 for storing the articles 112.

The system 100 can also include a central microprocessor 116, a user interface 118, a biometric identifier 120, a sobriety detection mechanism 122, a payment receiver 124 and a communications circuit 126. Control and data interfaces can be provided for permitting the central microprocessor 116 to control the operation of the storage unit 110, the user interface 118, the biometric identifier 120, the sobriety detection mechanism 122, the communications circuit 126 and the payment receiver 124.

The sobriety detection mechanism 122 can be constructed to determine whether a user of the system 100 is inebriated, intoxicated or otherwise under the influence of alcohol or drugs. In one arrangement, the sobriety detection mechanism 122 can receive a breath sample from a user and can analyze that sample for the presence of, for example, alcohol. Alternatively, the sobriety detection mechanism 122 can receive a body part from a user, such as a finger, and can analyze the refraction of light through the body part to determine a person's blood alcohol content (BAC). Those of ordinary skill in the art, however, will appreciate that the sobriety detection mechanism 122 can be designed to detect the presence of other intoxicants in a user's system. Examples of several sobriety detection mechanisms 122 in accordance with the inventive arrangements will be discussed below.

The biometric identifier 120 can be used to measure at least one biometric characteristic of a user. Implementing a biometric identifier 120 into the system 100 can serve two purposes: (1) it can collect biometric data from a user and can verify subsequent collections of such data to ensure that the stored article 112 is not released to an unauthorized person; and (2) it can ensure that the person providing the sample to the sobriety detection mechanism 122 is the one intended to give the sample. Examples of biometric characteristics that can be measured include a user's fingerprint, a retinal scan or an iris scan. Those of ordinary skill in the art will appreciate that the biometric identifier 120 can be designed to identify and analyze other unique biometric characteristics. Several examples of suitable biometric identifiers 120 will also be presented below.

The payment receiver 124 can be used to secure payment for the operation of the system 100. To initiate or complete a transaction, the payment receiver 124 can accept paper money and coins as payment for the operation of system 100. Additionally, the payment receiver 124 can accept payment from electronic transactional cards such as credit cards, debit cards or stored value cards. Those of ordinary skill in the art will appreciate that the payment receiver 124 is not limited to any particular model or system, as the design and implementation of such devices are well known.

The communications circuit 126 can be any communications system suitable for contacting one or more entities when it receives a signal from the central microprocessor 116. As an example, the communications circuit 126 can be a standard telephone system that can transmit and receive telephone signals over the primary switching telephone network (PSTN) (not pictured). Alternatively, the communications circuit 126 can be a wireless communications system capable of transmitting and receiving signals through a wireless communications link 128. Any suitable radio frequency (RF) standard can be used to transmit signals over the wireless communications link 128. As defined herein, RF means any electromagnetic wave that can be propagated wirelessly through a suitable medium. In another arrangement, the communications circuit 126 can include a modem for transmitting and receiving data over a communications network such as the Internet.

In either embodiment, the communications circuit 126 can transmit a service signal to a receiving entity such as a transportation service receiving mechanism 130. This service signal can be a prerecorded message informing a transportation service, e.g., a taxi, a tow truck or a delivery service, that a user of the system 100 needs assistance. A delivery service can be, for example, an organization that provides persons unable to drive a free rides to their destinations. It is understood that the invention is not limited to these examples, as the communications circuit 126 can contact any service or entity suitable for ferrying passengers. The prerecorded message can be an audio recording capable of being received by the transportation service receiving mechanism 130. Alternatively, the prerecorded message can be a visual message capable of being displayed by a monitor. In either embodiment, the message can include the location of the system 100, and, hence, the whereabouts of the person needing assistance.

The user interface 118 can display information to a user of the system 100. For example, the user interface 118 can display instructions to a user for operating the system 100 and can display the results of the measurements taken by the sobriety detection mechanism 120. In one arrangement, the user interface 118 can be a liquid crystal display (LCD) to enable its operation in brightly lit areas.

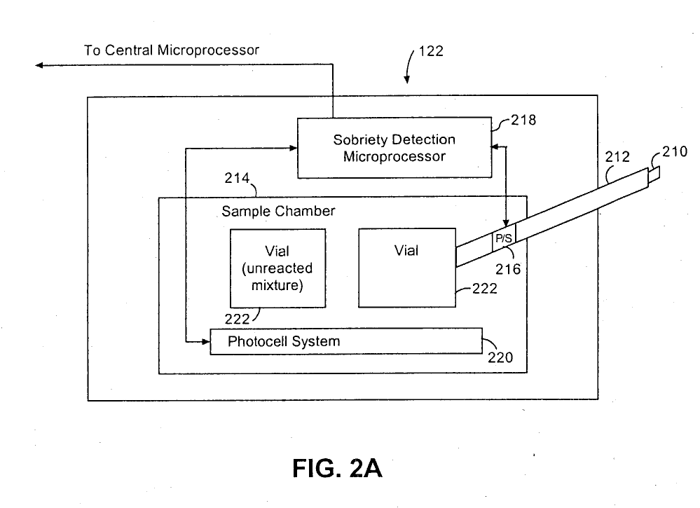

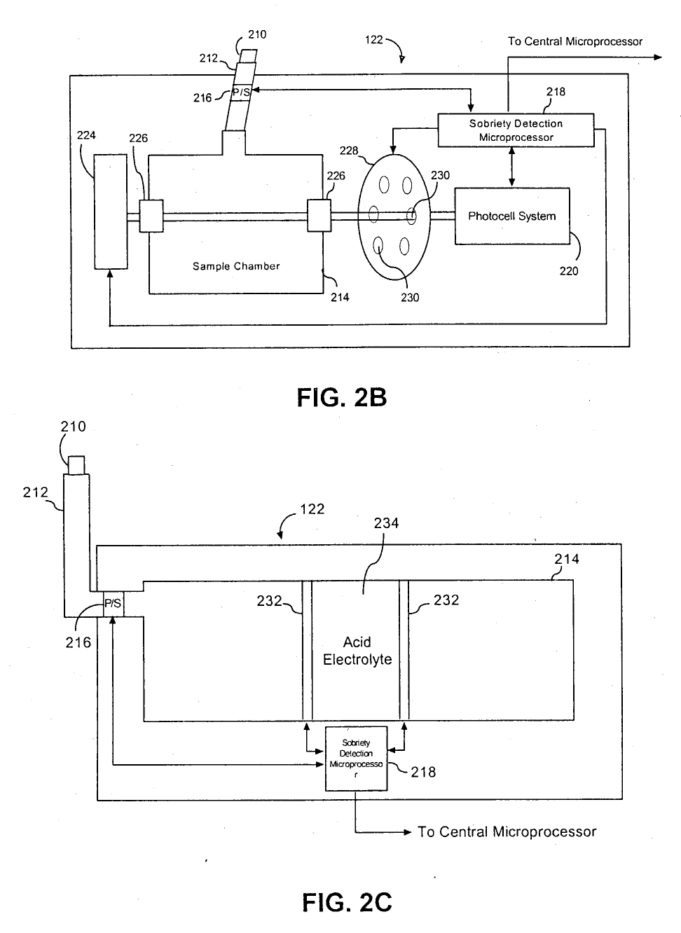

Referring to FIGS. 1 and 2A, a sobriety detection mechanism 122 in accordance with the inventive arrangements is shown. This particular example illustrates the sobriety detection mechanism 122 as a breath alcohol testing device commonly referred to as a Breathalyzer. Such a device relies on chemical reactions involving alcohol to determine a person's BAC. The sobriety detection mechanism 122 can include a mouthpiece 210, a tube 212, a sample chamber 214, a pressure switch 216, a sobriety detection microprocessor 218, a photocell system 220 and a plurality of vials 222 for storing the chemicals used in the breath analysis. The tube 212 can be attached to the mouthpiece 210 and can channel exhaled air from a user to the sample chamber 214. To prevent the spread of communicable diseases and to ensure overall sanitary conditions, the mouthpiece 210 can be a disposable elongated tube that can be conveniently thrown away following its use, such as a plastic straw.

Additionally, the photocell system 220 and the vials 222 can be contained within the sample chamber 214, and the pressure switch 216 can be located within the tube 212. In one arrangement, the pressure switch 216 can be designed to electrically close when the air pressure at its input reaches a predetermined threshold. The sobriety detection microprocessor 218 can control the operation of the photocell system 220 and can receive signals from the pressure switch 216. The sobriety detection microprocessor 218 can also receive signals from and transmit signals to the central microprocessor 116.

As the user's breath passes through the tube 212, the air pressure at the input of the pressure switch 216 will increase. If the pressure reaches the predetermined threshold, the pressure switch 216 can electrically close thereby signaling the sobriety detection microprocessor 218 that an acceptable breath sample has been received. If the sobriety detection microprocessor 218 receives no signal from the pressure switch 216 within a predetermined amount of time, the sobriety detection microprocessor 218 can signal the central microprocessor 116. In response, the central microprocessor 116 can prompt the user interface 118 to request the user to provide another breath sample. After the sobriety detection microprocessor 218 receives the signal from the pressure switch 216, the microprocessor 218 can signal the photocell system 220.

The breath sample can enter the sample chamber 214 and can be bubbled through a chemical mixture in at least one of the vials 222 thereby causing a chemical reaction. As an example, the breath sample can be bubbled through a mixture including sulfuric acid, potassium dichromate, silver nitrate and water. By products of this reaction include chromium sulfate, potassium sulfate and acetic acid. During this reaction, reddish-orange dichromate ions change color to the green chromium ions when they react with alcohol present in the breath sample. The degree of this color change is directly related to the level of alcohol in the expelled air.

The photocell system 220 can compare the vial 222 containing the reacted mixture to a vial 222 containing an unreacted mixture. Based on the difference in color between the two mixtures, the photocell system 220 can generate an electrical signal and can transmit the signal to the sobriety detection microprocessor 218. The sobriety detection microprocessor 218 can produce a BAC reading based on the electrical signal and can forward the reading to the central microprocessor 116.

Referring to FIG. 2B, another sobriety detection mechanism 122 in accordance with the inventive arrangements is shown. In this example, the sobriety detection mechanism 122 can use infrared spectroscopy, a technique that identifies molecules based on the way they absorb light, to determine a user's BAC. Devices of this nature are commonly referred to as Intoxilyzers. Similar to the breath alcohol testing device discussed in relation to FIG. 2A, the sobriety detection mechanism 122 of FIG. 2B can include a mouthpiece 210, a tube 212 attached to the mouthpiece 210 and a sample chamber 214 in which the tube 212 can direct the user's expelled breath to the sample chamber 214. In addition, the sobriety detection mechanism 122 can include a pressure switch 216, a sobriety detection microprocessor 218 and a photocell system 220.

The sobriety detection mechanism 122 can also have a light source 224 for emitting infrared light, one or more lenses 226 for focusing the infrared light emitted from the light source 224 and a rotatable filter wheel 228. In one arrangement, the light source 224 can be a quartz lamp capable of emitting a broadband (or multiple wavelength) infrared beam. The sobriety detection microprocessor 218 can control the operation of the light source 224, the photocell system 220, the filter wheel 228 and can receive signals from the pressure switch 216.

As is known in the art, each type of chemical bond within a molecule absorbs infrared light at different wavelengths. The amount of ethanol—the alcohol found in alcoholic beverages—in a breath sample is directly proportional to the wavelengths at which the infrared light is absorbed by the ethanol bonds and the amount of infrared light absorbed by these bonds. As a result, the filter wheel 228 can contain a plurality of narrow band filters 230 specific to the wavelengths at which the chemical bonds in ethanol will absorb the infrared light.

In operation, a user can provide a breath sample, and the pressure switch 216 can signal the sobriety detection microprocessor 218 if the pressure increase from the breath sample reaches the predetermined threshold. If so, the sobriety detection microprocessor 218 can activate the light source 224, the filter wheel 228 and the photocell system 220. The infrared light passes through the sample chamber 214 (and the breath sample), and the lenses 226 can focus the light onto the filter wheel 228. As the filter wheel 228 rotates, the infrared light can pass through the narrow band filters 230 and on to the photocell system 220.

The amount of infrared light that reaches the photocell system 220 is inversely proportional to the level of ethanol in the breath sample. For example, the lower the amount of infrared light that reaches the photocell system 220, the greater the amount of ethanol that is in the breath sample. The photocell system 220 can convert the received infrared light to an electrical signal and can transmit this signal to the sobriety detection microprocessor 218, which can generate a BAC from this signal and can forward the reading to the central microprocessor 116.

Referring to FIG. 2C, yet another example of a sobriety detection mechanism 122 in accordance with the inventive arrangements is illustrated. In this particular example, the sobriety detection mechanism 122 can employ fuel cell technology to determine a person's BAC. The sobriety detection mechanism 122 can include a mouthpiece 210 attached to a tube 212, which can guide a user's breath sample to a sample chamber 214. The sobriety detection mechanism 122 can also have a pressure switch 216 and a sobriety detection microprocessor 218.

In one arrangement, the sobriety detection mechanism 122 can include at least two electrodes 232, preferably constructed of platinum, and an acid electrolyte 234, which can be sandwiched between the electrodes 232. The sobriety detection microprocessor 218 can be electrically coupled to the pressure switch 216, the central microprocessor 116 and the two electrodes 232; the sobriety detection microprocessor 218 can be coupled to the two electrodes through a wire 234.

As the user exhales, the pressure switch 216 signals the sobriety detection microprocessor 218 when the sample reaches the predetermined threshold. The breath sample can enter the sample chamber 214 from the tube 212, the exhaled air can flow across one of the electrodes 232 and the electrode 232 can oxidize any ethanol present in the sample to produce acetic acid, protons and electrons. The electrons can flow through the wire 234 and on to the other electrode 232. The protons can move through the acid electrolyte 234, where they can combine with the electrons and oxygen from the breath sample to form water.

The amount of alcohol in the breath sample is directly proportional to the electrical current flowing through the wire 234. For example, the more alcohol that becomes oxidized in the sample chamber 214, the greater the number of electrons that will flow through the wire 234. Based on this electrical current, the sobriety detection microprocessor 218 can produce a BAC reading and can transmit this reading to the central microprocessor 116.

Referring to FIG. 2D, another example of a sobriety detection mechanism 122 in accordance with the inventive arrangements is shown. This sobriety detection mechanism 122 operates on a principle similar to the sobriety detection mechanism 122 discussed in relation to FIG. 2B except that no breath sample is required here. The sobriety detection mechanism 122 can include a housing 236 having one or more apertures 238 for receiving a body part such as a finger. The housing 236 can contain at least one light source 240 and a spectroscopic detector 242 in which the light source 240 and the spectroscopic detector 242 can be positioned such that they substantially face one another. The housing 236 can also include a sobriety detection microprocessor 218, which can be coupled to and control the operation of the light source 240 and the spectroscopic detector 242.

The light source 240 can emit a polychromatic light beam and can be, for example, a tungsten-halogen lamp or one or more light emitting diodes. For purposes of this arrangement, the term light can encompass electromagnetic radiation both within and outside the visible spectrum. In one arrangement, the light source 240 can emit light in the near infrared region having a wavelength from about 650 nm to 2700 nm. The spectroscopic detector 242 can sense the intensity of different wavelengths of the light emitted from the light source 240 and can transmit this intensity information to the sobriety detection microprocessor 218. As an example and without limitation, the spectroscopic detector 242 can employ diffraction grating to sense these intensities.

In operation, the central microprocessor 116 can signal the sobriety detection microprocessor 218, which can activate the light source 240 and the spectroscopic detector 242. The user can place his or her body part in the aperture 238. The light emitted from the light source 240 can pass through the body part, and the spectroscopic detector 242 can measure the intensities of the emitted light that it receives. As those of ordinary skill in the art know, ethanol has a sharp spectral absorbency at approximately 1190 nm, and the intensity of the light emerging from the body part near this frequency is inversely proportional to the amount of alcohol in the path of the emitted light. Thus, a low intensity of light near such a frequency, as detected by the spectroscopic detector 242, can indicate a high BAC.

The spectroscopic detector 242 can transfer the intensity information to the sobriety detection microprocessor 218, which can compare the measured intensity information with the intensity of the wavelengths emitted by the light source 240. Based on this comparison, the sobriety detection microprocessor 218 can generate a BAC and can transmit this reading to the central microprocessor 116.

It is understood that the invention is in no way limited to the foregoing examples, as any other suitable device can be used for determining whether a person is sober or otherwise substantially free of mind altering substances or intoxicants. In fact, those of ordinary skill in that art will appreciate that one or more of the sobriety detection mechanisms 122 discussed above can be configured to detect substances other than alcohol.

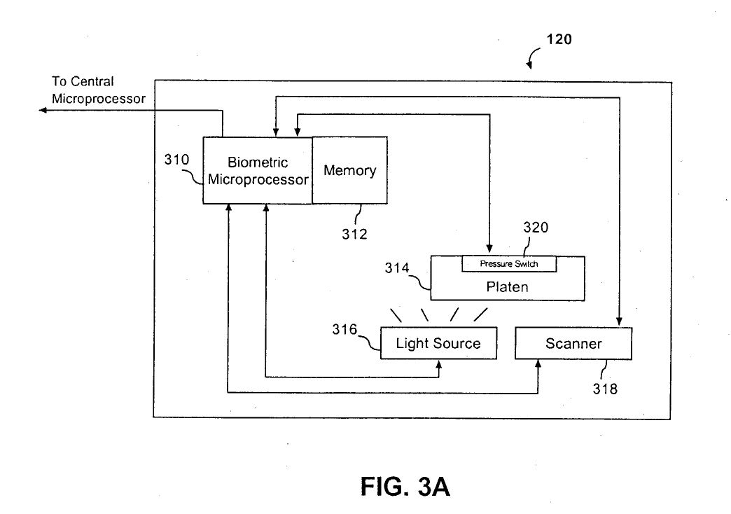

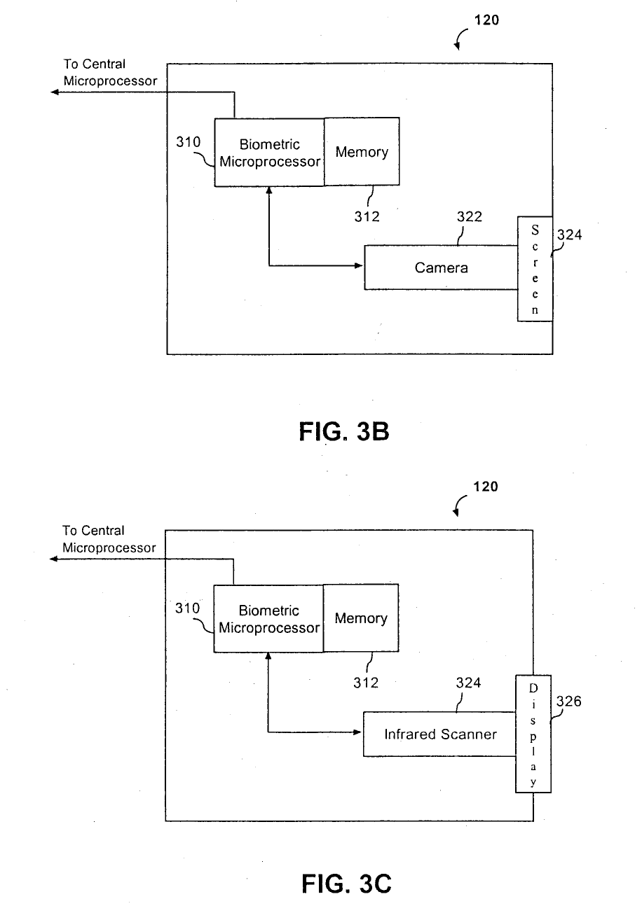

Referring to FIG. 3A, one example of a biometric identifier 120 in accordance with the inventive arrangements is shown. In this example, the biometric identifier 120 can generate digitized images of fingerprints, store the images and compare them with subsequently acquired fingerprint images. The biometric identifier 120 can include a biometric microprocessor 310 containing memory 312, of which at least a portion can be non-volatile, a platen 314, a light source 316, a fingerprint scanner 318 and a pressure switch 320.

The light source 316 can direct light towards the platen 314 and can be, for example, a light emitting diode. The platen 314 can also be transparent to the wavelength of the emitted light and can contain the pressure switch 320, which can be electrically coupled to the biometric microprocessor 310. The pressure switch 320 can detect when a user has placed his or her finger on the platen 314 and can signal the biometric microprocessor 310. In addition, the biometric microprocessor 310 can control the operation of the light source 316 and the fingerprint scanner 318. The fingerprint scanner 318 can be any biometric device capable of scanning fingerprint images and, if necessary, converting these images into digitized images.

In operation, a user can place his or her finger on the platen 314, and the pressure switch 320 can signal the biometric microprocessor 310. The biometric microprocessor 310 can signal the fingerprint scanner 318 and the light source 316, which can emit the light needed to create a scanned image of the user fingerprint. The light can pass through the platen 314 and can strike the user's finger, which can cause the light to be reflected to the fingerprint scanner 318.

From the reflected light, the fingerprint scanner 318 can generate a scanned image of the user's fingerprint and can convert the image into a digital signal. The fingerprint scanner 318 can forward this signal to the biometric microprocessor 310, which can store the digitized image in memory 312. The biometric microprocessor 310 can compare subsequent digitized images captured in accordance with the above description with the digitized image stored in memory 312. The biometric microprocessor 310 can signal the central microprocessor 116 (see FIG. 1) with the results of the comparison.

In another arrangement, the biometric identifier 120 can capture an image of a user's iris for use as the measured biometric characteristic. An example of such a biometric identifier 120 is shown in FIG. 3B. Here, the biometric identifier 120 can include a biometric microprocessor 310 having non-volatile memory 312, a camera 322 and a screen 324 for protecting the camera 322. The biometric microprocessor 310 can control the operation of the camera 322.

When the biometric identifier 120 is ready to measure a user's iris, the biometric microprocessor 310 can signal the camera 322, which can capture images of the user's iris and can convert these images into a digital signal. The camera 322 can be any camera suitable for recording images of a person's iris and converting these images, if necessary, into digital signals. The camera 322 can transmit the digitized images of the user's iris to the biometric microprocessor 310, which can store the signal in memory 312. Similar to the system described in relation to FIG. 3A, the biometric microprocessor 310 can compare the stored digitized image with subsequent acquired images and can signal the central microprocessor 116 (see FIG. 1) with the results of the comparison.

Yet another example of a biometric identifier 120 in accordance with the inventive arrangements is illustrated in FIG. 3C. Like the two examples previously described with respect to FIGS. 3A and 3B, the biometric identifier 120 of FIG. 3C can include a biometric microprocessor 310 and memory 312. In this example, however, the biometric identifier 120 can include an infrared scanner 324 for mapping the capillary pattern on the back of a person's retina. The infrared scanner 324 can also convert this image into a digital signal. The infrared scanner 324 can be any suitable scanner for performing retinal scans and for converting the scanned images, if necessary, into a digital signal.

For an initial retinal scan (when no information concerning a user's retina is currently stored within memory 312), the infrared scanner 324 can also include a display 326. The display 326 can project images of a target that a user must track with his or her eyes to permit the infrared scanner 324 to map the capillary pattern, a process that is well known in the art and warrants no further description. The biometric microprocessor 310 can control the operation of the infrared scanner 324 and the display 326.

In operation, the biometric microprocessor 310 can signal the infrared scanner 324 to perform a retinal scan. Once so done, the infrared scanner 324 can digitally convert the images and can transmit this image to the biometric microprocessor 310, which can store the digitized image in memory 312. The biometric microprocessor 310 can compare the stored digitized image with subsequent digitized retinal images and can signal the central microprocessor 116 with the results of the comparison.

Although several examples of biometric identifiers 120 have been presented, it is important to note that the invention is in no way limited to these particular systems. Those of ordinary skill in the art will appreciate that other systems suitable for measuring biometric characteristics can be used. In fact, the invention does not require the use of biometric identifier, as the system 100 of FIG. 1 can operate without such a device.

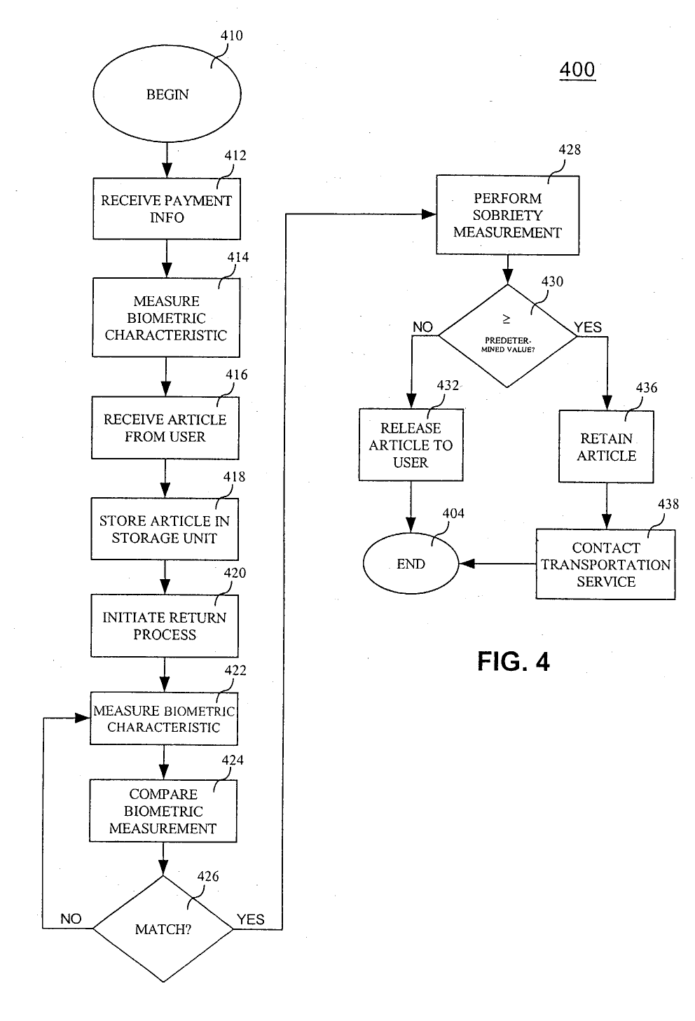

As shown in FIG. 4, a method 400 that shows an example of the operation of the system 100 of FIG. 1 is presented. The system 100 of FIG. 1 will be used to help explain the operation of the method 400; however, the method 400 is not limited to use in the system 100, as the method 400 can be used with any other suitable system. At step 410, the process can begin, and the user interface 118 can provide payment instructions to a user. At step 412, the payment receiver 124 can receive payment information. Once the payment information is verified, the user interface 118 can prompt the user to provide an appropriate biometric sample, and the biometric identifier 120 can measure the biometric characteristic, as shown at step 414. At this point, if a user has never before used the system 100, the measurement of the biometric characteristic can be stored in memory.

At step 416, the user interface can prompt the user to deposit the article 112 to be stored in the system 100, and the article 112 can be stored in the storage unit 110, as shown in step 418. At step 420, when the user is ready to retrieve the stored article 112, the user interface 118 can instruct the user to once again provide a biometric sample. At step 422, the biometric identifier 120 can measure the biometric characteristic and can compare this measurement with other samples stored in memory, as illustrated at step 424.

At decision block 426, if the measured characteristic does not match any biometric files in storage, the method 400 can resume at step 422, and the user interface 118 can request the user to provide another biometric sample. If there was a match, the method 400 can continue at step 428, where the user interface can instruct the user to supply the appropriate sobriety sample for analysis by the sobriety detection mechanism 122. At decision block 430, if the sobriety detection mechanism 122 determines that the measured sobriety sample is below a predetermined value, the sobriety detection mechanism 122 can signal the central microprocessor 116, which can signal the storage unit 110 to release the article 112, as shown at step 432.

As an example, the predetermined value can be a BAC value that matches a BAC legal limit set by a particular state's legislature. Of course, the predetermined value is not limited to this example and can be any suitable value for determining whether the user is intoxicated or otherwise under the influence of a mood altering substance. The user interface 118 can display the sobriety reading and can inform the user that the article 112 will be released. The method 400 can stop at step 434.

Referring back to decision block 430, if the sobriety sample produces a measurement that meets or exceeds the predetermined value, the sobriety detection mechanism 122 can signal the central microprocessor 116, which can signal the storage unit 110 to retain the article 112, as shown at step 436. In addition, the user interface 118 can display the sobriety measurement and can inform the user that the article 112 will be retained. At step 438, the central microprocessor 116 can signal the communications circuit 126 to contact an appropriate transportation service. Finally, the method 400 can stop at step 434.

Although the present invention has been described in conjunction with the embodiments disclosed herein, it should be understood that the foregoing description is intended to illustrate and not limit the scope of the invention as defined by the claims

What is claimed is:

1. An automated depository system, comprising:
a sobriety detection mechanism; and
a storage unit for storing a deposited article;
wherein said storage unit selectively releases said deposited article based on measurements taken by said sobriety detection mechanism.

2. The system of claim 1, wherein said sobriety detection mechanism provides a blood alcohol content reading;
wherein said storage unit releases said deposited article when said blood alcohol content reading is below a predetermined value.

3. The system of claim 1, wherein said sobriety detection mechanism provides a blood alcohol content reading;
wherein said storage unit retains said deposited article when said blood alcohol content reading reaches a predetermined value

4. The system of claim 1, further comprising circuitry for contacting a transportation service based on measurements taken by said sobriety detection mechanism.

5. The system according to claim 4, wherein said sobriety detection mechanism provides a blood alcohol reading;
wherein said circuitry contacts said transportation service when said blood alcohol reading reaches a predetermined value.

6. The transportation service of claim 4, wherein said transportation service is a taxi.

7. The transportation service of claim 4, wherein said transportation service is a tow truck.

8. The transportation service of claim 4, wherein said transportation service is a delivery service.

9. The system of claim 1, further comprising structure for receiving payment from a user.

10. The system of claim 9, wherein said structure includes circuitry for receiving data from an electronic transactional card.

11. The system of claim 1, further comprising a user interface.

12. The system of claim 11, wherein said user interface displays measurements taken by said sobriety detection mechanism.

13. The system of claim 12, wherein at least one of said measurements is a blood alcohol content reading.

14. The system of claim 1, further comprising a biometric identifier for identifying at least one biometric characteristic of an individual using said system.

15. The system of claim 14, wherein at least one of said biometric characteristics is a fingerprint.

16. The system of claim 14, wherein at least one of said biometric characteristics is a retinal scan.

17. The system of claim 14, wherein at least one of said biometric characteristics is an iris scan.

18. The system of claim 1, wherein said article is a key.

19. A method of automatically storing articles, comprising the steps of:
storing at least one article in a storage unit;
taking measurements of an individual with a sobriety detection mechanism; and
selectively releasing the stored article based on the measurements taken by the sobriety detection mechanism.

20. The method of claim 19, further comprising the step of contacting a transportation service if warranted by the measurements taken by the sobriety detection mechanism.

21. The method of claim 19, further comprising the steps of:
providing a biometric identifier; and
identifying at least one biometric characteristic of an individual with the biometric identifier.
